(19) United States
(12) Patent Application Publication
(10) Pub. No.: US 2026/0300133 A1
(43) Pub. Date: Oct. 1, 2026

(54) Systems and Methods For Detecting Duplicate Bug Reports

(71) Applicant: Bugcrowd Inc., San Francisco, CA (US)

(72) Inventors: Muskan Gupta, Milpitas, CA (US); Ian Conway, San Francisco, CA (US)

(21) Appl. No.: 19/095,535

(22) Filed: Mar. 31, 2025

(51) Int. Cl. G06F 11/362

(52) U.S. Cl. CPC G06F 11/362

(57) ABSTRACT

Techniques are disclosed for detecting duplicate bug reports or BRs submitted in one or more bug bounty programs across one or more organizations. For this purpose, a custom feed-forward neural network (FENN) is trained on feature sets of BR pairs derived from a set or corpus of BRs. The feature sets are generated by a feature engineering pipeline (FEP). The FENN outputs a set of probabilities/scores, one for each BR pair. Each probability of the set indicates whether the BRs in the corresponding BR pair are duplicates of each other. A threshold is identified from the set, above which a BR pair is considered to have duplicates, otherwise not. The FEP is then used to derive feature sets of a new BR paired with other BRs in a given scope. The trained FENN is then executed on these feature sets to determine if the new BR is duplicative of any existing BRs in the scope.

### REFERENCE TO COMPUTER PROGRAM LISTING APPENDIX

This application includes a computer program listing appendix containing a file in ASCII text file format and submitted via EFS-Web. The entire contents of the computer program listing appendix including the below named file are incorporated by reference herein in their entireties in this application. The name, size, creation date and a brief description of the file contained in the computer program listing appendix is provided in Table 1 below.

Note that prior to uploading via EFS-Web, the “.json” extension of the original file referenced in the below table was changed “_json.txt”.

TABLE 1
Name, size, creation date and a brief description of the file
contained in the submitted computer program listing appendix.

| | Size of | | |
|---|---|---|---|
| | the | | |
| | File | Creation | |
| Name of the File | (bytes) | Date | Brief Description |
| 1. vulnerability-rating- | 87,854 | Mar. 18, 2025 | Vulnerability |
| taxonomy.txt | | | Rating Taxonomy |
| | | | (VRT) specified in |
| | | | JSON format |

### FIELD OF THE INVENTION

This invention is generally related to a deep learning neural network-based classification model and more specifically to detecting duplicate bug reports by employing deep learning via a custom feed-forward neural network.

### BACKGROUND ART

The detection of IT vulnerabilities and IT security remains an area of active interest among government agencies and private sector entities, both large and small, private and public. The news of vulnerability exploits, and hacking of IT assets is a familiar phenomenon to most business professionals in today's interconnected world. Unsurprisingly, a lot of attention and focus has been devoted by many organizations and academic institutions in developing platforms, tools and ideas that can detect vulnerabilities and misconfigurations in an organization's IT infrastructure.

A timely detection of the vulnerabilities/bugs in an IT infrastructure is essential for their proper and timely remedy/fix. As a consequence of timely fixes of these bugs or vulnerabilities, their exploitation by adversaries can be prevented. Otherwise, such exploitation can have catastrophic consequences for the respective businesses, organizations and/or their customers/partners.

In a bug bounty program, “triage” refers to the process where a dedicated expert or team reviews bug reports submitted by security researchers and evaluates their validity and severity. The triaging expert/team also determines if a new bug report is a duplicate of a bug report previously submitted by the researchers. A key function of the triage is to separate valid vulnerabilities from irrelevant or duplicate reports, ensuring only critical issues reach the development team. Therefore, it is paramount that the triaging team/expert is able to efficiently and accurately perform deduplication or in other words, detect bug reports that are duplicates.

There is a plethora of prior art that has attempted to address this issue in the industry. U.S. Patent Publication No. 2023/0315843 A1 to Yona et al. describes systems and methods for analyzing alerts with respect to cybersecurity issues that are indicated in the alerts in order to identify at least one group of matching alerts. Each group of matching alerts includes alerts generated by multiple cybersecurity detection tools. At least one group of duplicate alerts is identified among the groups of matching alerts based on associations returned by a software component associations database. The software component indicated by a first alert of each group of duplicate alerts is associated with the software component indicated by a second alert of the group of duplicate alerts. The alerts are managed based on the groups of duplicate alerts.

U.S. Patent Publication No. 2023/0388330 A1 to Zelivansky et al. discloses a system for examining details of a security advisory against informal vulnerability records. The system generates a vulnerability match confidence value based on comparison of different details in the security advisory against the informal vulnerability records. Based on the comparisons, the system determines similarity of different details between the security advisory and the informal vulnerability records and cumulatively updates a vulnerability match confidence value with various detail similarity weights according to the determined similarities. Based on the vulnerability match confidence value, the system can classify or designate a security advisory for automatic merging or for manual examination. This reduces the burden on cybersecurity personnel and allows cybersecurity personnel to focus their limited resources on analyzing new vulnerabilities.

U.S. Patent Publication No. 2017/0300698 A1 to Chawla et al. teaches a vulnerability report evaluation system that comprises a preprocessor that takes as its input a data record representing a vulnerability report and outputs a search record. The vulnerability report evaluation system further comprises a search engine and a searchable corpus comprising records of vulnerabilities, wherein the search engine is configured to use the outputted search record to search the corpus. The vulnerability report evaluation system can flag search result hits resulting from the searched search record as an indication that the submitted vulnerability report is a duplicate of an earlier vulnerability report or as a flag to trigger manual review.

U.S. Pat. No. 10,387,659 B1 to Youngberg et al. discloses a system for performing deduplication of findings and includes a non-transitory computer readable medium and a processor. The non-transitory computer readable medium stores normalized findings of application code performed by at least one software security analysis tool. Each normalized finding is identifiable by a fingerprint. The processor receives a first finding in a first vendor-provided format from a first software security analysis tool that performs a scan of application code. The processor receives a second finding in a second vendor-provided format from a second software security analysis tool. The processor normalizes the findings to a standardized taxonomy. The processor determines a first fingerprint and a second fingerprint that respectively identify the normalized first and second findings. The processor determines any need to update the normalized first finding by comparing the normalized second finding with the normalized first finding after determining that the second fingerprint at least partially matches the first fingerprint.

U.S. Pat. No. 9,678,820 B2 to OlmstedThompson et al. discloses systems, methods, and for non-transitory machine readable media for alerting with duplicate suppression. An example non-transitory machine readable medium can store instructions executable by a processing resource to cause a computing system to receive an alert at a first virtual computing instance (VCI) from a second VCI, compare the alert with at least one previously received alert to determine if the alert is a duplicate alert, and send the alert to an alert notification queue associated with the first VCI in response to a determination that the alert is not a duplicate alert. In some embodiments, the medium can store instructions to confirm that the alert has been sent in response to the determination that the alert is a duplicate alert.

U.S. Pat. No. 10,291,643 B2 to Marquez et al. teaches a method for validating a vulnerability submitted by a tester in a crowdsourcing environment. The method comprises identifying at least one vulnerability within at least one computer resource and receiving vulnerability data corresponding to the at least one vulnerability. The method further comprises pre-processing the vulnerability data to generate structured data and generating a replica of the vulnerability using the structured data and at least one validator. Further, the method comprises calculating a confidence score of the vulnerability using the replica of the vulnerability and a result of the at least one validator. The method executes at least one validating instruction based on the confidence score of the vulnerability.

The article entitled “A Soft Alignment Model for Bug Deduplication” by Rodrigues et al. dated October 2020, teaches that Bug tracking systems (BTS) are widely used in software projects. The authors argue that an important task in such systems consists of identifying duplicate bug reports, i.e., distinct reports related to the same software issue. They state that for several reasons, reporting bugs that have already been reported is quite frequent, making their manual triage impractical in large BTSes. In the article, the authors present a deep learning network based on soft-attention alignment to improve duplicate bug report detection. For a given pair of possibly duplicate reports, the attention mechanism computes interdependent representations for each report, which is more powerful than previous approaches. They evaluate their model on four well-known datasets derived from BTSes of four popular open-source projects. Their evaluation was based on a ranking-based metric, which was more realistic than decision-making metrics used in many previous works. Achieved results purportedly demonstrate that their model outperforms state-of-the-art systems and baselines in different scenarios. Finally, an ablation study was performed by them to confirm that the proposed architecture improves the duplicate bug reports detection.

The article entitled “POSTER: DWEN: Deep Word Embedding Network for Duplicate Bug Report Detection in Software Repositories” to Budhiraja dated May 2018 discloses an approach for duplicate bug report detection. The approach is based on word embeddings and deep learning for computing bug report similarity. The authors purport that the proposed approach is able to perform better than baselines and related approaches. The aim of the authors is to reduce the training to a single step compared to the two-step training process of training embeddings and deep neural network.

Despite the abundance of prior art, there is still no effective and accurate solution for detecting duplicate bug reports. This is because the prior art systems fall short of properly and effectively encoding bug reports into feature vectors containing relevant features. The prior art systems also do not effectively train machine learning systems as feed forward neural networks trained on the feature vectors for duplicate bug report detection. As a consequence of the inefficacies of the prior art, the detection of duplicate bug reports remains a manual and cumbersome task.

### OBJECTS OF THE INVENTION

In view of the shortcomings of the prior art, it is an object of the present invention to effectively perform duplicate bug report detection.

It is further an object of the invention to perform duplicate bug report detection by first deriving feature sets for bug report pairs by using a feature engineering pipeline (FEP) of the present design.

It is also an object of the invention to represent the feature sets by feature vectors that can then be used to train a feed-forward neural network (FFNN).

It is further an object of the invention to output a set of probabilities by the FENN, each of which indicates if the corresponding pair of bug reports contains duplicates.

It is further an object of the invention to identify a threshold from the above set of probabilities above which a bug report pair is considered to contain duplicates, otherwise not.

It is also an object of the invention to derive a second group of bug report pairs containing a new bug report paired with existing bug reports.

It is further an object of the invention to execute the trained FENN on the second set of bug report pairs to produce a second set of probabilities.

It is also an object of the invention to identify those probabilities from the second set of probabilities that are equal to or above the identified threshold.

Still other objects and advantages of the invention will become apparent upon reading the detailed description in conjunction with the drawing figures.

### SUMMARY OF THE INVENTION

The objects and advantages of the invention are secured by systems and methods for a duplicate bug report detection system based on the present principles. Such a system comprises a first set or corpus of bug reports that have been accumulated over time. Preferably, the bug reports or BRS or submissions or vulnerability reports have been accumulated as a result of a number of bug bounty programs that have been run overtime and in which researchers or white-hat hackers have submitted the bug reports.

According to the chief aspects, a first group of all possible pairs of bug reports is generated from the above first set of BRs. The pairwise bug reports are commutative in nature i.e. the order of the bug reports appearing in a bug report pair is immaterial to the present design. The pairing of bug reports may be performed by a feature engineering pipeline (FEP) whose main responsibility is to generate feature sets for the pairwise bug reports or bug report pairs. Alternatively, the pairing may be performed by a separate module.

Instant FEP accomplishes its objectives by deriving a feature set for each bug report pair or BR pair of the first group of BR pairs derived above. The feature set includes the respective features of each individual BR in the BR pair, as well as features that are in turn derived from the combined features of both the individual BRs of the pair.

The FEP first derives features for each BR by encoding or transforming it according to feature engineering techniques of the present design. More specifically, the FEP employs a vulnerability rating taxonomy (VRT) to encode the tags of a BR based on whether they are present in the VRT or not. FEP also encodes the priority level of the BR, as well as its other textual components, including its description and caption. FEP also encodes the address or uniform resource locator (URL) of the BR and the target specified/identified in the BR. Once features for each BR in the BR pair have been derived, FEP derives additional or combined features based on the features thus derived for the individual BRs.

Collectively, all the features derived from the individual BRs in the BR pair as well as the combined features are referred to as the feature set for the BR pair. Such a feature set is represented by the FEP as a feature vector. All such feature vectors for all BR pairs derived from the above first set of BRs comprise the first group of feature vectors. Because all the feature vectors in this first group have the same length, they are also referred to herein as fixed-length feature vectors or simply fixed-length vectors.

There is also a feed forward neural network (FENN) of the present design that undergoes tuning in order to determine the optimal values of its hyperparameters. In parallel, the FENN is also trained on the first group of fixed-length feature vectors derived for respective BR pairs of the above first group of BR pairs. The FFNN generates a set or list of probabilities or scores, one for each input feature vector and ultimately for the BR pair that resulted in that feature vector. Each such score generated by the FENN for a given BR pair indicates whether the BR pair is a duplicate, or in other words, has BRs that are duplicative/duplicates of each other.

From the above set of probability scores generated by FFNN, a duplicate bug report probability/score threshold is identified. This may be accomplished manually by a human expert, automatically or programmatically, or by a combination of manual and automatic techniques. Such a threshold indicates the minimum score above which a BR pair would be considered to contain duplicate BRs. In other words, if a score or entry in the above set of probabilities/scores is equal to or above the threshold, then this indicates that the corresponding pair of BRs is a duplicate, otherwise not.

Once the instant FFNN has been tuned and trained, or simply trained for short, and a duplicate bug report/submission/BR probability/score threshold identified per above, the present duplicate bug report detection system is ready to score a hitherto unknown or unseen BR. Such a BR may have already existed, or may be an incoming or a new BR.

The determination of whether the new BR is a duplicate or not i.e. its scoring is performed within a specified scope. In the preferred embodiment, the scope is defaulted to an organization or customer. What this means is that the instant duplicate BR detection system scores or evaluates the new BR by comparing it against all the BRs that been submitted for that organization/customer, past and present.

In an alternative embodiment, the scope is a specific bug bounty program. What this means is that the new BR is compared against all the BRs that have previously been submitted in that specific bug bounty program. In still other embodiments, the scope is any collection of bug programs bounty across one or more organizations.

In order to score the new BR, a second group of BR pairs is first generated for the specified/applicable scope, such that each BR pair includes the new BR. In other words, a second group of pairwise BRs or BR pairs is derived from the new BR and the BRs existing in the specified/applicable scope. Still differently put, the new BR is paired with every BR existing in the scope in order to derive this second group of BR pairs. The set of BRs already existing in the specified scope are also referred to as the second set of bug reports/BRs.

Then the FEP is used to derive a second group of feature sets for respective BR pairs in the second group of BR pairs. This second group of feature sets is also represented by a second group of respective fixed-length feature vectors. The FEP accomplishes the above in a manner analogous to the way it generated the first group of feature vectors for the first group of BR pairs discussed above.

The trained FENN is now executed on this second group of feature vectors. As a result, instant trained FENN produces a second set or list of probabilities/score each indicating whether the corresponding input BR pair contains duplicates. According to the main aspects, those scores that are above the duplicate BR score threshold identified above are presented. If there any scores equal to or above the threshold, then this indicates that the new BR is a duplicate of a BR already present in the applicable scope, otherwise not. Of course, the BR that the new BR is a duplicate of (or vice versa), is the other BR in the BR pair that resulted in the score greater than or equal to the above threshold.

A preferred embodiment of the present technology uses the instant duplicate bug report detection system in a bug report triaging pipeline/system. Such an embodiment greatly alleviates the burden on a human expert/team who would otherwise have to manually review each new BR. In the same or a related embodiment, there is a submission or BR receiving module that is responsible for receiving the new BR.

In the same or a related embodiment, the tuning of the FENN is performed based on Receiver Operating Characteristic-Area Under the Curve (ROC AUC) scores derived from a test portion of the first set of bug reports. In the same or a related embodiment, the training of the FENN is performed by partitioning the BRs in the first set/corpus of BRs above into training, test and validation portions.

In the same or a related embodiment, the FENN has an input or first layer with Rectified Linear Unit (ReLU) activation and Batch Normalization. In the same or a related embodiment, there are three hidden layers in the above FENN for deep learning. In the same or a related embodiment, the FENN has an output layer one neuron with sigmoid activation for binary classification.

In the same or a related embodiment, the instant FEP uses one-hot-encoding to encode the tags of BRs based on the VRT. In the same or a related embodiment, the instant FEP uses label encoding to encode the priority levels of the BRs. In the same or a related embodiment, the instant FEP uses a specialized version of the BERT (Bidirectional Encoder Representations from Transformers) model that is adapted for cybersecurity or security-related tasks, referred to herein as secBERT, for encoding the textual components of the BRs. These textual components include their descriptions and captions among others.

In the same or a related embodiment, the instant FEP encodes the URLs of the BRs based on the number of backslashes (“\”) in the URLs. In the same or a related embodiment, the instant FEP creates a feature in the feature set of the BR pair by comparing the targets specified in the BRs.

The methods of the present technology include a computer-implemented method for executing by at least one microprocessor, computer-readable instructions stored in a non-transitory storage medium coupled to said at least one microprocessor, said computer-implemented method comprising the steps of: (a) deriving by a feature engineering pipeline, a first group of feature sets for respective pairs of bug reports in a first set of bug reports, said deriving based on a vulnerability rating taxonomy, priority levels of said bug reports, textual components of said bug reports, uniform resource locators of said bug reports and targets identified in said bug reports, wherein said first group of feature sets is represented by a first group of respective fixed-length feature vectors; (b) tuning and training a feed forward neural network to obtain a trained feed forward neural network, said training based on said first group of fixed-length feature vectors, wherein said feed forward neural network generates a first set of probabilities, each corresponding to a pair of bug reports amongst said respective pairs of bug reports in said first set of bug reports; (c) identifying a duplicate bug report probability threshold from said first set of probabilities; (d) receiving a new bug report and deriving by said feature engineering pipeline, a second group of feature sets for respective pairs of bug reports derived from said new bug report and a second set of bug reports, wherein said second group of feature sets is represented by a second group of respective fixed-length feature vectors; and (e) running said trained feed forward neural network on said second group of fixed-length feature vectors to generate a second set of probabilities for said respective pairs of bug reports derived from said new bug report and said second set of bug reports, and identifying those amongst said second set of probabilities that are equal to or greater than said duplicate bug report probability threshold.

The systems and apparatus of the present design include a computer system comprising computer-readable instructions stored in a non-transitory storage medium and at least one microprocessor coupled to said non-transitory storage medium when executing said computer-readable instructions, said computer system further comprising: (a) a first set of bug reports; (b) a feature engineering module for deriving a first group of feature sets for respective pairs of bug reports in said first set of bug reports, said deriving done by employing a vulnerability rating taxonomy, priority levels of said bug reports, textual components of said bug reports, uniform resource locators of said bug reports and targets identified in said bug reports, wherein said first group of feature sets is represented by a first group of respective fixed-length feature vectors; (c) a feed forward neural network trained on said first group of fixed-length feature vectors, wherein said feed forward neural network generates a first set of probabilities, each corresponding to a pair of bug reports amongst said respective pairs of bug reports in said first set of bug reports, and wherein a duplicate bug report probability threshold is identified from said first set of probabilities; and (d) a submission receiving module for receiving a new bug report; wherein said feature engineering module is used to derive a second group of feature sets for respective pairs of bug reports derived from said new bug report and a second set of bug reports, and wherein said second group of feature sets is represented by a second group of respective fixed-length feature vectors, and wherein said feed forward neural network is executed on said second group of fixed-length feature vectors to generate a second set of probabilities for said respective pairs of bug reports derived from said new bug report and said second set of bug reports, and wherein those probabilities are identified amongst said second set of probabilities that are equal to or greater than said duplicate bug report probability threshold.

Clearly, the systems and methods of the invention find many advantageous embodiments. The details of the invention, including its preferred embodiments, are presented in the below detailed description with reference to the appended drawing figures.

### BRIEF DESCRIPTION OF THE DRAWING FIGURES

FIG. 1 shows an embodiment of a duplicate bug report detection system of the present design.

FIG. 2 represents another embodiment of a duplicate bug report detection system detailing bug report pairs and the corresponding feature sets.

FIG. 3 shows a workflow as well as related components for describing the workings of an instant feature engineering pipeline.

FIG. 4 shows an architecture of a custom feed-forward neural network that is trained to detect duplicate bug reports according to the present principles.

FIG. 5 shows a variation of FIG. 2, focused on determining whether a new bug report is duplicative of bug reports already existing in a specified scope.

FIG. 6 illustrates how an instant duplicate bug report detection system is used in a bug report triaging pipeline.

### DETAILED DESCRIPTION

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

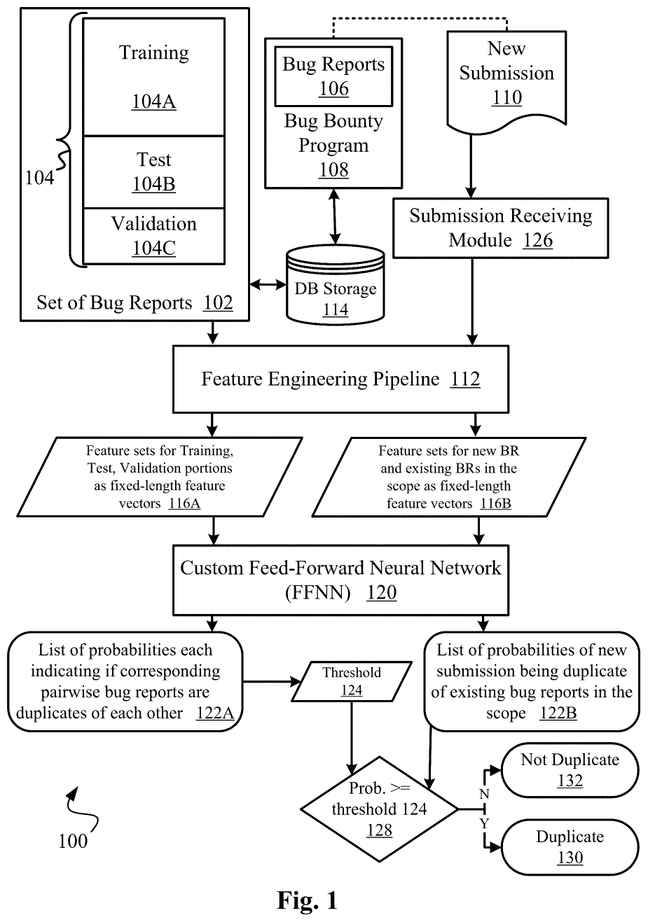

The present invention will be best understood by first reviewing a system 100 for detecting duplicate bug reports or submissions as illustrated in FIG. 1. There is an existing corpus or set 102 of bug reports or BRs or submissions or vulnerability reports 104 stored in a database 114 as shown. Database 114 is persistent and may be on premise or in the cloud, such as, in one or more Amazon Simple Storage Service (S3) buckets. Corpus/set 102 contains bug reports from one or more bug bounty programs for various customers, clients or organizations. Bug reports or submissions 104 in corpus 102 are used to train a custom feed forward neural network 120 according to the teachings provided herein. More specifically, when a new BR or a new submission 110 in a bug bounty program 108 is received by a submission receiving module 126, neural network 120 detects if the new submission 110 is a duplicate of BRs/submissions already present in a specified scope.

Depending on the embodiment, the detection of duplicate bug reports can be performed at a variety of scopes or levels or search spaces. In one embodiment, the duplicate detection or deduplication is performed at the scope of a specific bug bounty program, e.g. bounty program 108. In another embodiment, the duplicate detection is performed across all the bounty programs of a given customer/organization. Each customer or organization is assigned a unique organization identifier/id or Org-ID or org-id by the present technology. In still other embodiments, the duplicate detection is performed across any selected set of bug bounty programs/bounties of just one or even multiple organizations/customers.

Instant duplicate bug report detection or duplicate submission detection is accomplished by first training a custom feed-forward neural network (FFNN) 120 on bug reports 104 already in corpus/set 102. According to the chief aspects, bug reports 104 in corpus 120 are partitioned into a training portion 104A, a test portion 104B and a validation portion 104C as shown in FIG. 1. There is a feature engineering pipeline or module 112 that derives feature sets from portions 104A-C of existing bug reports 104. The feature sets are represented by a group of feature vectors 116A of predetermined or fixed length.

As a consequence, for all pairs of bug reports in set 102, respective fixed-length feature vectors 116A are generated by feature engineering pipeline 112. Each such fixed-length feature vector or simply fixed-length vector contains features generated for the first bug report in a pair of bug reports. The fixed-length vector also contains features generated for the second bug report in the bug report pair. Furthermore, the fixed-length vector also contains features that are derived from a combination of features generated for the first and the second bug reports in the pair.

This first group or collection of fixed-length feature vectors 116A for the training, test and validation portions 104A-C of bug reports 104 are then used to train feed-forward neural network (FFNN) 120. Alongside training, custom FENN 120 is also tuned to derive the optimal values of its hyperparameters as will be taught further below. For brevity, we may refer to a tuned and trained FENN 120 as simply a trained FENN 120.

Once trained, neural network 120 is used to generate a set or list of duplicate probability scores or probability scores or simply probabilities or scores 122A. An entry in set/list 122A is a probability p that the corresponding pair of bug reports in set of bug reports 102 are duplicates of each other. The pair of bug reports were transformed/encoded into a feature set represented by a fixed-length feature vector in vectors 116A and which caused FENN 120 to generate the above probability/score p. Then, from the above set 122A of probabilities/scores, duplicate bug report probability threshold 124 is either manually or automatically or semi-automatically identified. If a probability from list of probabilities 122A is equal to or above threshold 124, then that means that the pair of bug reports represented by that probability are considered duplicates, otherwise not.

Once, custom feed forward neural network 120 has been tuned and trained and threshold 124 has been identified based on set/corpus 102 of BRs, system 100 is ready to receive a new BR/submission 110 and to determine if it is duplicative of any existing BRs. BR 110 is advantageously received by a submission receiving module 126. The BR belongs to an active bounty program 108 in which researchers are submitting new BRs for a target or targets specified for the bug bounty program.

Depending on the embodiment, BR/submission receiving module 126 may comprise a textual interface, a GUI or a file-based interface and may be loosely or tightly integrated with the rest of system 100. Regardless, a researcher or a hacker would submit new submission 110 via submission receiving module 126. BR/submission 110 is then processed by feature engineering pipeline or module 112 in a manner similar to the processing of bug reports in set 102.

Depending on the scope of bug detection per above, new BR/submission 110 is first paired with the existing bug reports that are available within the specified scope or search space. We may also refer to such existing BRs in the scope as the second set of bug reports/BRs. In the embodiment shown in FIG. 1, the scope is bug bounty program 108. As such, new BR 110 is paired with all existing BRs 106 that have previously been submitted for bug bounty program 108. The bug report pairs after this pairing of new BR 110 with the second set of bug reports, are also stored in a persistent storage. Preferably, such a persistent storage is database storage 114 introduced above.

Pipeline/module 112 now derives a second group/set of feature sets for respective pairwise bug reports in the bug report pairs derived above. These feature sets are represented as a second group/collection of fixed-length feature vectors 116B in a manner analogous to the first group of fixed-length vectors 116A discussed above. Fixed-length vectors 116B are now provided as inputs to now trained neural network 120. In response, trained FENN 120 outputs a set/list of probabilities 122B. Each element/entry in set/list 122B indicates whether the corresponding pair of bug reports, one of which is new BR 110 and the other an existing BR within the scope, are duplicates of each other. As noted above, in the embodiment shown in FIG. 1, the scope or duplicate detection search space is bug bounty program 108.

Now, per decision diamond 128, if a probability in set/list 122B is greater than or equal to threshold 124, then new BR 110 is considered to be duplicative of the other BR in the corresponding bug report pair. As a result, new BR/submission 110 is identified as a duplicate per terminator 130 as shown. Otherwise, new BR 110 is identified as not a duplicate (or as a unique BR in bounty program 108) per terminator 132 shown in FIG. 1. Of course, if the scope of duplicate detection were a customer or an organization (with a unique org-ID), then terminator 132 would signify that the new BR is unique across all bounty programs for that organization.

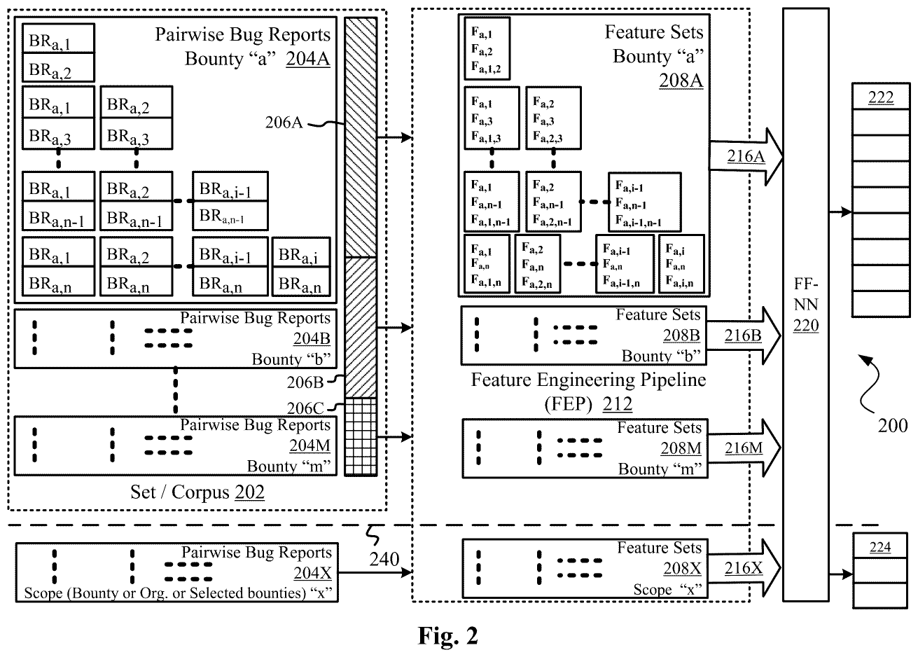

Let us now look at FIG. 2 to understand the workings of duplicate bug report detection technology of the present design in even greater detail. FIG. 2 illustrates an embodiment 200 in which there is a corpus or set 202 which houses the bug reports of various bug bounty programs “a”, “b”, . . . “m”. Any number of bug reports or BRs or submissions of any number of such bug bounty programs or simply bounties may be stored in corpus 202. In order to avoid distraction from the main principles being taught, a persistent storage or a database storing corpus 202 and other data elements as well as other technical components of the architecture of embodiment 200 are not explicitly shown in FIG. 2 but are presumed to exist.

The bug reports in each bounty a-m are organized into pairs as shown. More specifically, in a bounty “a” with n BRs and a submission of interest “i” or the i-th submission, the pairwise BRs consist of the following BR pairs: (BR_{a,1}, BR_{a,2}), (BR_{a,1}, BR_{a,3}), . . . (BR_{a,1}, BR_{a,n-1}), (BR_{a,1}, BR_{a,n}), (BR_{a,2}, BR_{a,3}), (BR_{a,2}, BR_{a,4}), . . . (BR_{a,2}, BR_{a,n-1}), (BR_{a,2}, BR_{a,n}), . . . (BR_{a,i-1}, BR_{a,n-1}), (BR_{a,i-1}, BR_{a,n}), (BR_{a,i}, BR_{a,n}). These pairwise Bug Reports or pairwise BRs are marked by reference numeral 204A in FIG. 2 as shown. There is also a bounty “b” with pairwise BRs 208B shown in an abbreviated form in FIG. 2 to avoid clutter, and so on up until bounty “m” with pairwise BRs 208M in set/corpus 202.

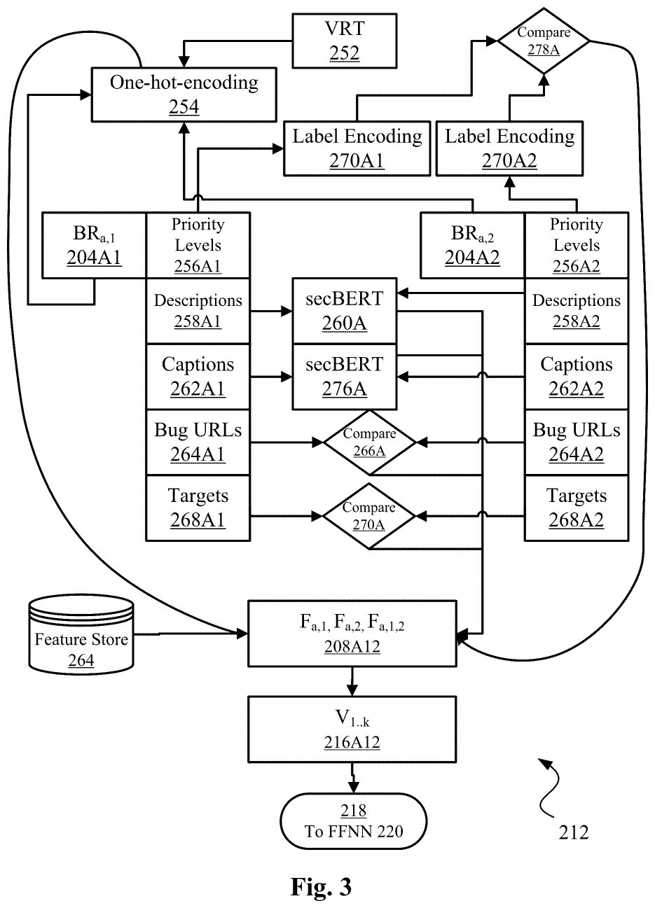

According to the chief aspects, a feature engineering pipeline (FEP) 212 of the instant design is used to encode or transform the BRs in bounties a-m into feature sets. More specifically, FEP 212 transforms each pair of BRs into a set of features according the feature engineering scheme of the present design. To understand the feature engineering employed by the present technology, let us review FIG. 3 in conjunction with FIG. 2.

### Feature Engineering:

FIG. 3 shows the workings of feature engineering pipeline 212 introduced above in reference to FIG. 2. There are a number of inputs provided to feature engineering module or pipeline 212 in order to derive features 208. These features, denoted in FIG. 2 by the letter “F” for brevity, are subsequently provided as vectors to an instant neural network. One input to FEP 212 are pairwise bug reports 204A, 204B, . . . , 204M of bug bounty programs “a”, “b”, . . . , “m” respectively as discussed above. Only one such pair of bug reports (BR_{a,1}, BR_{a,2}) marked by reference numerals 204A1 and 204A2 are shown in FIG. 3 in order to teach the feature engineering capabilities of the present design without distraction.

Another input to feature engineering pipeline/module 212 is vulnerability rating taxonomy (VRT) 252. VRT 252 is a standardized framework for classifying and prioritizing security vulnerabilities discovered during bug bounty programs and penetration tests. It serves as a guideline for both security researchers and organizations, ensuring a consistent approach to assessing the severity and impact of vulnerabilities.

The computer program listing appendix submitted herewith, and which is incorporated by reference in its entirety for all purposes, describes a vulnerability rating taxonomy of the present technology in JavaScript Object Notation (JSON) format. In a preferred embodiment, VRT 252 is the VRT specified in the computer program listing appendix. However, in an alternative embodiment, VRT 252 is any standardized framework for classifying and prioritizing vulnerabilities.

In the same or another embodiment, one-hot-encoding 254 is used to encode the VRT tags within a BR, e.g. BR_{a,1}. However alternative forms of encoding of the VRT tags are conceivable. More specifically for the preferred embodiment, if a given tag that is specified in VRT 252 is also present in the BR, a respective column in features/F 208 is set to 1, otherwise it is set to 0. For example, let us assume that VRT 252 has 200 tags, each corresponding to a type of vulnerability, and let us further assume that BR_{a,1} has 3 vulnerabilities mentioned that are contained in the 200 VRT tags above. Then based on the instant principles, among other columns, features F_{a,1} in feature set 208A12 will contain 200 columns corresponding to the 200 tags of VRT 252. 3 of these 200 columns in F_{a,1} corresponding to the vulnerabilities mentioned in BR_{a,1} will be set to 1, while the other 197 columns will be set to 0. Alternatively, the 3 columns may be set to 0, and the remaining 197 columns may be set to 1.

Another input to FEP 212 is the priority levels or simply priorities 256 of the BRs. In the example shown in FIG. 3, there is priority level 256A1 for BR 204A1 and priority level 256A2 for BR 204A2. The priority level of a bug refers to its level of importance which in turn determines how quickly the bug should be fixed. The priority level helps allocate resources effectively to address issues in a way that minimizes risk and impact. According to the instant design, there are 5 levels of priority:
1. P1 (Critical/High): Requires immediate attention and a fix as soon as possible. Examples: Data breaches, system crashes, or vulnerabilities exposing sensitive user data.
2. P2 (High): Significant issues that impact functionality but may not require an immediate fix. Examples: Major UI bugs that hinder usability but do not expose security risks.
3. P3 (Medium): Moderate impact bugs that can be addressed in regular updates or maintenance cycles. Examples: Minor inconsistencies, bugs with workarounds.
4. P4 (Low): Minor issues that have minimal impact and can be deferred. Examples: Cosmetic issues or enhancements.
5. P5 (Informational): Usually does not require a fix but serves as a suggestion or as an informational note. Examples: Logging recommendations, coding best practices.

Based on the current feature engineering scheme, first the priority levels are preferably encoded by label-encoding. However alternative forms of encoding are conceivable. Such label-encoding of the priority levels of BRs 204A1 and 204A2 by respective process boxes/steps/blocks 270A1 and 270A2 is shown in FIG. 3. Then, as shown by comparison diamond 278A, the priority levels of the BRs in the pair are compared to populate another column in features 208A12 for the BR pair. To understand this better, let us continue with the example shown in FIG. 3. If BR_{a,1} has a priority level P1 and BR_{a,2} has a priority level P2, then features or feature set F_{a,1} will have a priority feature/column with an entry 1, while that feature/column in features or feature set F_{a,2} will have an entry 2. However, in the overall or combined features or combined feature set F_{a,1,2} for BRs BR_{a,1} and BR_{a,2}, there is another feature/column preferably named Normalized Priority Comparison. This feature/column will have a value of 0 in our example.

The Normalized Priority Comparison column has a value of 0 because the priority levels of BR_{a,1} and BR_{a,2} do not match. Otherwise, it would have had a value of 1. Collectively, feature sets or simply features F_{a,1}, F_{a,2} and F_{a,1,2} are known as the feature set for BR pair (BR_{a,1}, BR_{a,2}). This feature set for the BR pair is marked by reference numeral 208A12 in FIG. 3. Thus, feature set 208A12 contains the features transformed/derived/resulting/generated from BR pair (BR_{a,1}, BR_{a,2}) by FEP 212 of FIG. 2-3. In a similar fashion, feature sets 208A are derived for all pairwise BRs 204A. Furthermore, a group of features 208A-M is derived for all respective pairwise BRs 204A-M shown in FIG. 2.

In the preferred embodiment, the derived features 208 are stored in a persistent feature store. Such a feature store 264 is explicitly shown in FIG. 3 but not in FIG. 2 for reasons of clarity. As a consequence of feature store/database 264, the features of a given BR are only generated once. When the same BR is encountered in another BR pair, the features for that BR are simply fetched from feature store 264 by FEP 212 rather than recomputed/rederived.

While referring to FIG. 2-3, still another input to feature engineering pipeline 212 are descriptions 258 of the bug reports. In the example of FIG. 3, these are description 258A1 for BR 204A1 and description 258A2 for BR 204A2. A description is a textual component of a bug report that provides detailed information about the bug. It is a key component of the bug report and serves to clearly convey what the bug is, how it manifests, and the context in which it was encountered. A well-written description helps developers, testers, and other stakeholders understand the issue and aids in reproducing and resolving the bug.

FEP 212 encodes or embeds the descriptions of the BRs by using SecBERT 260A. secBERT is a specialized version of the BERT (Bidirectional Encoder Representations from Transformers) model that is adapted for cybersecurity or security-related tasks. BERT is a deep learning model used primarily in national language processing (NLP) to understand the context of words in a sentence. secBERT extends this model to the domain of cybersecurity. The term secBERT as used in this disclosure, refers to any appropriate version of the BERT model that is specialized for cybersecurity. Such a model is fine-tuned on cyber security reports for better contextualization of technical terms. A preferred embodiment utilizes an open-source implementation of such a specialized version of BERT available at https://github.com/jackaduma/SecBERT.

Instant embedding of a BR description is done by taking a pooled representation of its embedding provided by secBERT 260A and representing it as a set of 768 features in a preferred embodiment. These features are contained within feature set 208A12, which is represented by fixed-length vector 216A12 shown in FIG. 3.

Yet another input to FEP 212 of FIG. 2-3 are captions 262 of the bug reports. In the example of FIG. 3, these are caption 262A1 for BR 204A1 and caption 262A2 for BR 204A2. A caption is a textual component of a bug report that provides a concise title or summary that briefly describes the issue. It is often the first element reviewed by stakeholders, such as developers and testers, and serves as a quick identifier for the bug. A well-written caption helps prioritize, categorize, and locate bug reports efficiently. The caption is also embedded in a similar manner to the description above by using another or the same instance of secBERT. In the example of FIG. 3, secBERT instance for embedding captions is marked by reference numeral 276A. In a similar manner, FEP 212 may be used to encode any other textual components of the BRs.

Yet another input to feature engineering module 212 of FIG. 2-3 are the addresses of the bug reports. The addresses are preferably the uniform resource locators (URLs) 264 for the bug reports. In the example of FIG. 3, these are bug URL 264A1 for BR 204A1 and bug URL 264A2 for BR 204A2. A bug report URL or simply a bug URL is a hyperlink or web address or simply an address associated with a specific bug report. Based on the instant feature engineering design, there are two features that are created based on a bug URL:
1. Number of clicks that were used to find the bug. This feature is calculated by counting the number of backslashes (“\”) present in the bug URL as compared to the landing page that a researcher or a hacker found the bug in. The final feature for a submission pair is a boolean feature comparing whether the number of backslashes between the two BRs of a BR pair were the same or not. An exemplary bug URL is: “https://example, com/uploads/test.exe.”
2. Another feature created based on a bug URL is by comparing the bug URL string for the two BRs in a BR pair and creating a boolean feature in the combined feature set F_{a,1,2} of the BR pair discussed above. This comparison is shown by diamond 266A in FIG. 3. The value of the boolean feature is 1 if the URLs for the two BRs are identical, and 0 if they are not. Alternatively, the value of the feature may be 0 if the URLs are identical and 1 otherwise.

Still another input to FEP 212 of FIG. 2-3 are targets 268 for the BRs. In the example of FIG. 3, these are target 268A1 for BR 204A1 and target 268A2 for BR 204A2. The target in a bug report refers to the specific goal, component, feature, version, or environment where the bug is either observed or expected to be fixed. It provides context to the bug report, helping developers and other teams to focus their efforts on the affected area of the system or software. When a bug bounty program is set up, the program owner specifies the target, exemplarily a website or a web application, an API, a standalone or a distributed/networked system, a mobile application, an internet-of-things (IoT) device, among others. A unique target ID or target-ID is automatically generated for each target during the setup of a bug bounty program. This target ID is stored in the instant system in order to track bug reports related to that target.

Based on the instant design, for BR pair (BR_{a,1}, BR_{a,2}), a boolean feature is created in the combined feature set F_{a,1,2} of FIG. 3 discussed above. The boolean feature is based on the comparison of the target IDs specified in the two BRs of the BR pair. This comparison is shown by comparison diamond 270A in FIG. 3. In a manner analogous to bug URL, the value of the boolean feature in F_{a,1,2} is set to 1 if the target IDs are identical otherwise not. Alternatively, the value of the feature is set to 0 if the target IDs are identical otherwise the value is set to 1.

Thus, based on the instant feature engineering discussed above with the aid of FIG. 2-3, the feature set generated by FEP 212 for exemplary BR pair (BR_{a,1}, BR_{a,2}) comprises of features or feature set F_{a,1} derived from one individual BR (i. e. BR_{a,1}) of the BR pair, features or feature set F_{a,2} derived from the other individual BR (i.e. BR_{a,2}) of the BR pair, and combined features or a combined feature set F_{a,1,2} for the overall BR pair. These are collectively referred to as feature set for BR pair (BR_{a,1}, BR_{a,2}) and denoted by reference numeral 208A12 in FIG. 3.

Table 2 below shows the columns of such a feature set produced by FEP 212 in one exemplary implementation. More specifically, Table 2 shows feature sets F_{a,1}, F_{a,2} as well as combined features F_{a,1,2} for the exemplary implementation, with a total of 3718 features or columns. Note the column identifiers starting from 0 to 3717 above the column headings.

TABLE 2

| Combined Features - F_{a, 1, 2} | | | | Features of first BR - F_{a, 1} | | | Features of second BR - F_{a, 2} | | |
|---|---|---|---|---|---|---|---|---|---|
| 0 | 1 | 2 | 3 | 4-771 | 772-1539 | 1540-1860 | 1861-2628 | 2629-3396 | 3397-3717 |
| Normal- | Bug | Target | Sub | Descrip- | Caption | Encoded | Descrip- | Caption | Encoded |
| ized | URL | ID | URLs | tion | Embed- | VRT | tion | Embed- | VRT |
| Priority | Compar- | Compar- | Compar- | Embed- | dings | features | Embed- | dings | features |
| Compar- | ison | ison | ison | dings | | | dings | | |
| ison | | | | | | | | | |

These features are represented by a fixed-length vector V_{1,2, . . . , k} when output from FEP 212. In the example shown in Table 2 above, the fixed-length vector generated by FEP 212 has 3718 features i.e. k=3718. In such an exemplary implementation, there were approximately 65 million BRs/submissions in set 202 of FIG. 2.

Thus, feature engineering pipeline 212 produces a feature vector V_{1 . . . k} or simply feature vector V of k elements marked by reference numeral 216A12 for exemplary BR pair (BR_{a,1}, BR_{a,2}) shown in FIG. 3. Now, as shown by connector 218, feature vector 216A12 is then provided as input to custom FENN 220. In a similar manner, FEP 212 produces feature vectors 216A, 216B, . . . , 216M for all pairwise BRs in respective bounties “a”, “b”, . . . “m” shown in FIG. 2.

Since all of these feature vectors 216A-M have the same or fixed or predetermined number of elements k for a given implementation, they are referred to as fixed-length feature vectors. This group of fixed-length feature vectors or simply fixed-length vectors 216A-M is then provided as input to FFNN 220 for training. As discussed further herein, FENN 220 consequently produces a set or list 222A-M or simply list 222 of probabilities or scores for respective BR pairs 204A-M. Each of these probabilities/scores indicates whether the corresponding BR pair in BR pairs 204A-M contains duplicates i.e. whether the BRS in the BR pair are duplicates of each other.

FIG. 2 also shows pairwise bug reports 204X for a specified scope “x” in which duplicate bug report detection is performed. Such a scope or search space was already discussed above. Now, depending on the embodiment, scope “x” may be a specific bounty program, e.g. a currently active bounty program. Alternatively, scope “x” may be all the bounty programs of a given customer or an organization. Alternatively still, scope “x” may be any selection of bounties as shown. In a manner analogous to BR pairs 204A-M, FEP 212 derives a second group of feature sets 208X for pairwise BRs 204X in scope “x”.

This second group of feature sets is now represented by a second group of respective fixed-length feature vectors 216X (of the same length k per above teachings) and then provided to trained FENN 220 for inferencing. Analogously to set/list 222 discussed above, FENN 220 now produces a set or list 224X or simply list 224 of probabilities/scores for respective BR pairs 204X. Each of these probabilities/scores indicates whether the corresponding BR pair in BR pairs 208X contains duplicates i.e. whether the BRs in the BR pair are duplicates of each other.

It should be noted that the key responsibility of FEP 212 of FIG. 2-3 is to derive features 208 represented as feature vectors 216 for BRs 204. However, depending on the embodiment, the pairing of BRs into BR pairs or pairwise BRs may be performed by FEP 212 itself, or by another data processing module that then provides the BR pairs as input to FEP 212 for feature engineering.

### Data Partitioning:

Recall from the embodiment of FIG. 1 that existing bug reports in corpus 102 are partitioned into training, test, validation portions 104A, 104B and 104C respectively. In a similar fashion, pairwise bug reports 204 of FIG. 2 are partitioned into a training portion 206A, a test portion 206B, and a validation portion 206C as shown by the different hatched patterns of these data portions. Depending on the embodiment, this data partitioning may be performed before or after the pairing of BRs into BR pairs 204. Furthermore, the data partitioning may be performed within BR pairs 204A-M of respective bounty programs a-m, or across BRs 204 of all bounty programs a-m.

In any event, FEP 212 produces fixed-length feature vectors for each of training, test and validation portions/datasets/sets/subsets 206A, 206B and 206C respectively. More specifically, there is a group of fixed-length feature vectors Vₜᵣₐᵢₙ produced for the training portion 206A based on the prior teachings. Similarly, there is a group of fixed-length feature vectors Vₜₑₛₜ for test portion 206B, and there is a group of fixed-length feature vectors V_{validate} produced for validation portion 206C of bug reports in corpus 202. Each feature vector in groups or sets Vₜᵣₐᵢₙ, Vₜₑₛₜ and V_{validate} is produced by FEP 212 for the respective pairs of bug reports in corpus 202 in accordance with the feature engineering techniques taught above.

In the preferred embodiment, the data in corpus 202 of FIG. 2 is split into training, test, and validation portions 206A, 206B and 206C respectively based on the recency of the BRs/submissions. In the same or a related embodiment, for training and test portions or subsets 206A and 206B respectively, BRs that are older than a designated date and timestamp are randomly selected. Then, for validation portion 2060, the most recent BRs up to the above designated date and timestamp are included. The reason for this is so that the performance of the instant duplicate BR detection system can be evaluated based the most recent submissions, and so that custom feed-forward neural network (FENN) 220 can accommodate drift in the data. It is preferably ensured that the org-ids across all subsets 206A-C are mutually exclusive.

### Model Tuning and Training:

As mentioned, custom feed-forward neural network (FFNN) 120/220 of FIG. 1/FIG. 2 is used for identifying duplicates in pairwise BRs by processing respective feature vectors based on a classification model. We will now focus on the tuning and training of FENN 220 while admitting that the relevant teachings will apply analogously to FFNN 120 of FIG. 1.

In the preferred embodiment, the FENN is tuned by running sweeps on parts of training portion/subset i.e. 206A_{hyper}ϵ206A while being evaluated on parts of test portion 206B_{hyper}ϵ206B in order to optimize hyperparameters based on Receiver Operating Characteristic-Area Under the Curve (ROC AUC) scores. As a result of these hyperparameter sweeps, the optimal values of hyperparameters for FENN 220 are determined. These hyperparameters include learning rate, number of hidden layers, number of neurons per layer, activation function, batch size, optimizer, dropout rate, weight initialization, epochs, learning rate scheduler, l2 regularization (weight decay), momentum, gradient clipping and loss function.

In parallel to tuning, FENN 220 is also trained on all of training, test and validation portions/datasets 206A, 206B and 206C respectively. During training, the above-mentioned hyperparameters/weights get updated and tuned, as the model gets hyper-tuned. In other words, during training, the values or weights of the hyperparameters are varied and adjusted and the model for FENN 220 that yields the best results is chosen. Ultimately, the optimal values of hyperparameters for FENN 220 are determined.

### FFNN Model Architecture:

Based on FEP 212 and the above tuning, the model architecture of FENN 220 in a preferred embodiment is configured as below.
1. Input or First Layer: Preferably, 3718 features as noted above.
2. Preferably, 3 hidden Layers:
   a. Hidden Layer 1: Preferably, 128 neurons with ReLU activation and dropout.
   b. Hidden Layer 2: Preferably, 128 neurons with ReLU activation and dropout.
   c. Preferably, Hidden Layer 3: 128 neurons with ReLU activation and dropout.
3. Output Layer: Preferably, 1 neuron with sigmoid activation for binary classification.

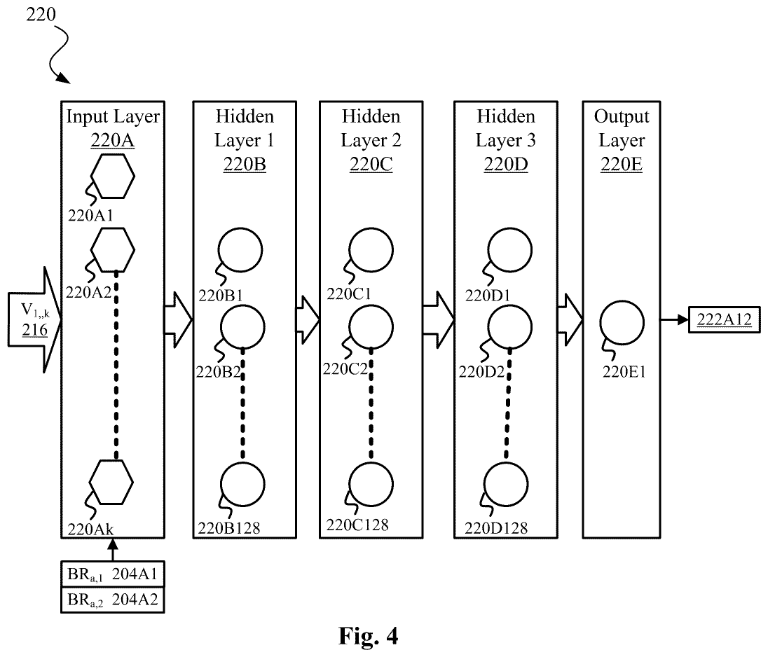

Such a deep learning architecture of custom FFNN 220 is illustrated in FIG. 4. As shown, there is an input/first layer 220A that receives feature vectors V_{1 . . . k} 216 of k features of the above teachings as input. The layer consists of k features 220A1, 220A2, . . . , 220Ak as shown. In the preferred embodiment as noted above, k=3718. Input layer 220A feeds into the first of the three hidden layers 220B, 220C and 220D as shown. Each of hidden layers 220B, 220C and 220D has respective 128 neurons 220B1, 220B2, . . . 220B128, 220C1, 220C2, . . . , 220C128 and 220D1, 220D2, 220D128 as shown. Finally, there is an output layer 220E with 1 neuron 220E1 as shown.

Once FENN 220 has been tuned and trained per above, for a given BR pair (BR_{a,1}, BR_{a,2}) as input to input layer 220A, custom FENN 220 outputs a probability 222A12 as to whether the pair of BRs BR_{a,1}, BR_{a,2} shown by respective reference numerals 204A1 and 204A2 is a duplicate i.e. whether BRs BR_{a,1}, BR_{a,2} are duplicates of each other.

### Runtime Operation:

Per above teachings, a custom FENN is first tuned and trained, or simply trained for short, on bug reports existing in a set or corpus of data. Such an FENN 120 and 220 and corpus 102 and 202 of BRs were discussed above in reference to FIG. 1 and FIG. 2 respectively. The FENN is then used to determine a duplicate bug report probability threshold 124 shown and discussed in reference to FIG. 1 above. If a BR pair has a probability score or simply probability or simply score above this threshold, then the BRs in the BR pair are considered duplicates, otherwise not. This is accomplished by an inference process of the present design.

Explained further, instant trained FENN is run on a set of preselected BR/submission pairs that are known to contain similar and different BR/submissions. By iteratively running the instant FENN on a number of such preselected BR pairs, a duplicate BR/submission threshold 124 is either automatically or alternatively manually or alternatively semi-automatically determined. Referring to FIG. 4, if probability 222A12 output by FENN 220 is equal to or above duplicate BR/submission threshold, then corresponding input pair of BRs i.e. BR_{a,1}/BR_{a,2} are considered to be duplicates, otherwise not.

Focusing now on FIG. 2 while admitting that relevant parts of the teachings apply analogously to FIG. 1, once FENN 220 has been trained and a duplicate BR/submission probability threshold determined per above, the system is ready to receive and score new BRs within a specified scope. Such a scope “x” with its pairwise bug reports 208X was shown in FIG. 2. The demarcation between the tuning/training or preprocessing of system 200 and its runtime operation is shown by dashed line 240. As taught above, the scope may be a specific bounty program or all the bounty programs across an organization or any selected set of bounty programs across one or more organizations.

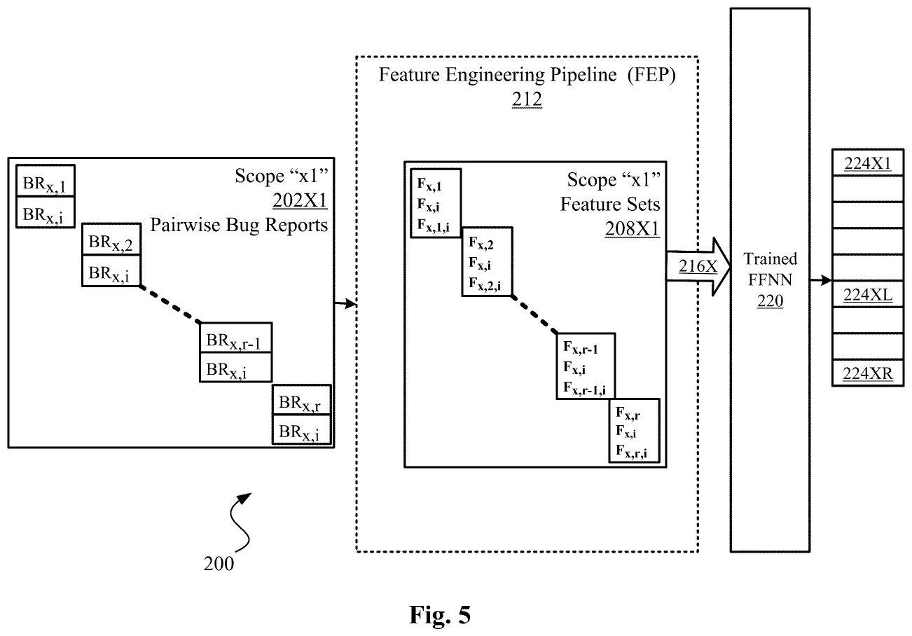

Let us now turn our attention to FIG. 5 to understand the runtime operation of system 200 in greater detail. When a new BR/submission BRᵢ is received by a submission receiving module (not shown in FIG. 5 to avoid clutter) for a scope “x”, a set of all possible BR pairs consisting of BRᵢ and existing BRs in scope “x” is first created. More specifically, in current scope “x” with r BRs and new BRᵢ or the i-th submission, the complete list of pairwise BRs consist of the following BR pairs: (BR_{x,1}, BR_{x,i}), (BR_{x,2}, BR_{x,i}), . . . (BR_{x,r-1}, BRᵢ), (BR_{x,r}, BR_{x,i}) as shown. Note that a given BR pair is commutative in the sense that the order of the BRs in the pair is immaterial.

Now, feature engineering pipeline (FEP) 212 creates corresponding feature sets for the above pairwise BRs per above teachings. These feature sets 208X for scope “x” are shown in FIG. 5. More specifically, feature sets 208X consist of features (F_{x,1}, F_{x,i}, F_{x,1,i}) for (BR_{x,1}, BR_{x,i}), features (F_{x,2}, F_{x,i}, F_{x,2,i}) for (BR_{x,2}, BR_{x,i}) and so on up until features (F_{x,r}, F_{x,i}, F_{x,r,i}) for (BR_{x,r}, BR_{x,i}) as shown. Features 208X are now presented as fixed-length feature vectors 216X and input to trained custom FFNN 220 in accordance with the above teachings.

In response, FENN 220 produces a list of r probabilities 224X1, 224X2, . . . , 224XL, . . . , 224XR each indicating whether BRᵢ is duplicative of an existing BR in scope “x”. Probabilities/scores 224X are presented in a descending order. If a score 224XL in scores 224X is greater than or equal to above-discussed duplicate BR threshold, then corresponding pair of input BRs i.e. (BRₗ, BRᵢ) that resulted in probability 224XL, are considered duplicates. Otherwise, they are considered non-duplicates. Notice the subscript “l” of BRₗ in (BRₗ, BRᵢ) corresponding to score 224XL.

The above process is repeated every time a new submission/BR is received by system 200 for scope “x”. If scope “x” is a given bounty program and the bounty program is new i.e. if no BRs have previously been received for it, then the first submission is automatically marked as a valid non-duplicate submission (VDNS). Then the features derived for it, or alternatively stated, its transformed features, are updated in the feature store. Such a feature store 264 was discussed in reference to FIG. 3 above.

The preferred embodiment of the present technology uses PyTorch™ for implementing FENNs 120 and 220. However, in alternative embodiments, custom FENN 120/220 can be implemented using other AI frameworks, including TensorFlow™, Keras™, Apache MXNet™, Caffe™, Theano™, Torch™, Microsoft Cognitive Toolkit (CNTK™), Chainer™, DL4J (DeepLearning4J™) and JAX™.

Similarly, the preferred implementation uses secBERT for textual embedding as taught above. However, alternative embodiments may employ other NLP models including BERT™, ROBERTa™, ALBERT™ DistilBERT™, DeBERTa™, GPT-3®, GPT-4®, T5™, XLNet™, ELECTRA™ BigBird™, ERNIE®, XLM™, XLM-R™, MBERT™, Mistral™, LLAMA®.

### Results:

The present technology is evaluated across different datasets to ensure that it is generalized across different organizations and can account for data drift that might be seen at least within a particular period of time. In addition to the training, test and validation data partitioning/splits explained above, the system is also evaluated on a sample of random BRs/submissions of unseen data. The system performs very well on these BRs/submissions as well, as shown in Table 3 below, where F1 Score is the harmonic mean of precision and recall as understood in the art.

TABLE 3

| | ROC AUC Score | Accuracy | F1 Scores |
|---|---|---|---|
| Training Set | 0.996 | 0.993 | 0.763 |
| Test Set | 0.984 | 0.972 | 0.719 |
| Validation Set | 0.958 | 0.98 | 0.411 |
| Random | 0.963 | 0.996 | 0.019 |
| Submission | | | |
| Sample | | | |

For completeness, Table 4 provides metrics for validation portion of the data, and Table 5 provides the confusion matrix for a validation portion of approximately 1.7 million BR pairs. As can be seen from Table 4, the actual duplicates that are undetected by the instant technology are only 2.5% of the overall dataset!

TABLE 4

| | Precision | Recall | F1 Score | Support |
|---|---|---|---|---|
| Non- | 0.98 | 1.00 | 0.99 | 1,460,049 |
| Duplicate | | | | |
| Duplicate | 0.70 | 0.38 | 0.49 | 39,951 |
| Accuracy | | | 0.98 | 1,500,000 |
| Macro Avg | 0.84 | 0.69 | 0.74 | 1,500,000 |
| Weighted Avg | 0.98 | 0.98 | 0.98 | 1,500,000 |

TABLE 5

| | Actual Non-Duplicate | Actual Duplicate |
|---|---|---|
| Predicted | 1,649,303 | 6,486 |
| Non-Duplicate | | |
| Predicted | 28,654 | 15,557 |
| Duplicate | | |

### Use in a Triaging Pipeline:

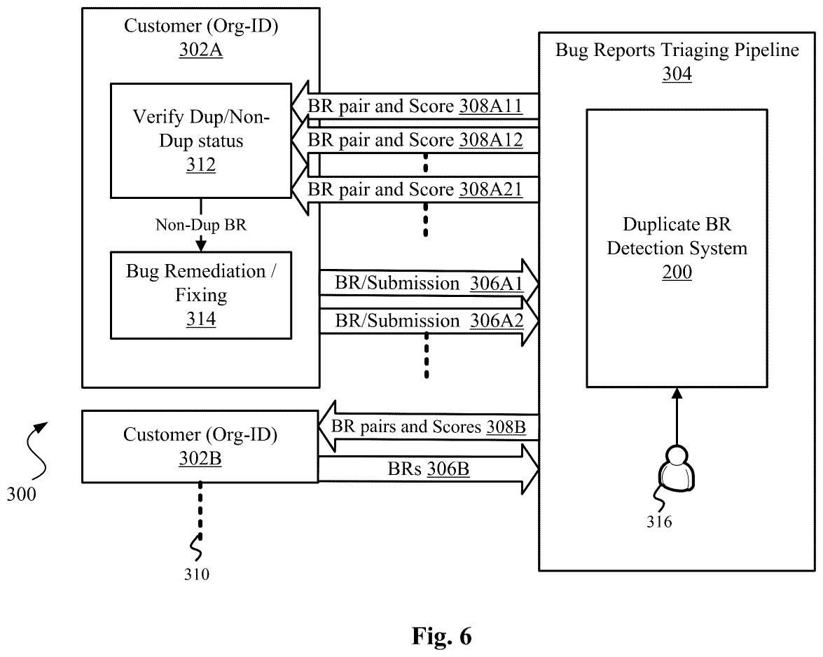

The duplicate bug report detection systems 100 and 200 of the above teachings can be effectively utilizing for bug report triaging as shown in FIG. 6. More specifically, FIG. 6 shows a bug detection and remediation environment 300 in which there are a number of customers or clients or organizations 302A, 302B, . . . , each having a unique organization identifier/id or Org-ID or org-id. There is a bug report triaging pipeline 304 that is benefited by a BR deduplication system 200 of FIG. 1-5 of the above teachings.

Each of customers 302 may have one or more bounty programs or simply bounties that may be currently active or may have been in the past. A customer/organization 302A submits one or more bug reports or submissions 306A to bug reports triaging pipeline or system 304. Two such BRs 306A1, 306A2, . . . are shown by respective block arrows in FIG. 6. Then based on prior teachings, for BR 306A1, BR deduplication system 200 generates BR pairs of BR 306A1 with all existing BRs in the applicable scope. Similarly, system 200 generates BR pairs of BR 306A2 with all existing BRs in the applicable scope, and so on.

Then, duplicate BR detection system 200 transforms each of these BR pairs into feature sets represented as a feature vector that is then processed by an instant trained custom FENN to produce a probability score as to whether the BR pair contains duplicate BRs. The steps and components of the instant technology for accomplishing the above tasks are not explicitly shown in FIG. 6 for clarity but were taught in detail above and are presumed to exist.

Now, FIG. 6 denotes by block arrow 308A11 the BR pair whose one element is BR 306A1 and the other element an existing BR in the applicable scope, as well as the associated score of the BR pair if greater than or equal to duplicate BR probability threshold discussed above. Similarly, FIG. 6 also denotes by block arrow 308A12 the BR pair whose one element is BR 306A1 and the other element another existing BR in the applicable scope, as well as the associated score of the BR pair if greater than or equal to duplicate BR probability threshold, and so on. Furthermore, FIG. 6 also denotes by block arrow 308A21 the BR pair whose one element is BR 306A2 and the other element an existing BR in the applicable scope, as well as the associated score of the BR pair if greater than or equal to duplicate bug report probability threshold, and so on.

Analogous to customer 302A, customer 302B submits BRs 306B to bug triaging pipeline 304 and in response receives BR scores 308B, and so on. As shown by dashed line 310, any number of customers 302 may be present that submit BRs 306 and receive respective BR scores 308 from triaging pipeline 304 containing duplicate BR detection system 200 of the instant design.

In the preferred embodiment, the duplicate BR detection performed by system 200 is over an organization or org-id. We refer to this by stating duplicate that scope of BR detection is the organization or org-id. In such an embodiment, the duplicate detection performed by system 200 is across all bounties, past and present, for a given customer, e.g. customer/organization 302A. The customer can thus learn if a given BR e.g. BR 306A2 submitted by a researcher, is duplicative of a BR submitted in another bounty program of customer 302A anytime in the past.

However, in an alternative embodiment, the scope of duplicate BR detection is only within an existing bounty program of a given customer, e.g. customer/organization 302B. We refer to this by stating that the scope or the search space is a given bounty, e.g. bounty “x”. Bounty “x” may be currently active or may have been active in the past. In such an embodiment, customer 302B can thus learn if a given BR, e.g. 306B19 is a duplicate of a BR e.g. 306B13 already submitted by a researcher in bounty “x”.

The scope may be specified as a part of BRs 306 or provided as a separate input or parameter by customers 302 to duplicate bug report detection system 200. In the preferred embodiment however, the scope is defaulted to be organization or org-id. Regardless, as shown in detail for customer 302A, once BR scores 308 are received, they are preferably reviewed or verified by the customer. This may be done by the customer either manually or automatically or semi-automatically as shown by process/box/block 312. If a BR is indeed a non-duplicate then it is sent off for bug-fixing or remediation as shown by block 314.

In a preferred embodiment, BR scores 308 generated by duplicate BR detection system 200 are first reviewed by a human operator or expert (or a team of experts) 316 before being sent to respective customer 302. This is to ensure that the results including any false positives or false negatives generated by the system can be first reviewed for accuracy by expert 316. However, given the effectiveness and accuracy of the present technology as demonstrated by the results presented above, the burden on human expert 316 is greatly alleviated.

More specifically, expert 316 may only need to review those BRs that have a score above/below a certain threshold e.g. duplicate BR probability score discussed above. In the prevailing systems, expert 316 would have had to review all BRs 306 sent by customers 302. The present technology thus greatly improves bug report triaging in the industry. Furthermore, as instant FENN 220 of system 200 is periodically trained and improved over time, its accuracy can ultimately reach a level that human expert 316 is completely eliminated.

For completeness, Table 6 shows a pair of exemplary bug reports in a tabular form from a preferred implementation of the present technology.

TABLE 6

| submission_id | abc123456 | def789012 |
|---|---|---|
| target_id | 12345 | 12345 |
| org-id | 56789 | 56789 |
| vrt | server_security_misconfig- | server_security_misconfig- |
| | uration.exposure_of_sensitive_infor- | uration.unrestricted_file_up- |
| | mation.logs_exposed | load.arbitrary_file.upload |
| description | During testing of the target | During testing of the target |
| | application, it was observed | application, it was |
| | that server logs were publicly | discovered that the file |
| | accessible without proper | upload functionality allowed |
| | authentication. These logs | for the upload of executable |
| | contained sensitive | files without proper |
| | information such as API keys | validation. This could allow |
| | and session tokens, which could | an attacker to execute |
| | lead to account compromise or | malicious scripts on the |
| | unauthorized access to the | server. |
| | application backend. | |
| caption | Exposed Server Logs Containing | Unrestricted File Upload |
| | Sensitive Information | Leading to Arbitrary Code |
| | | Execution |
| priority | 2 | 1 |
| bug_url | https://example.com/logs/2024- | https://example.com/uploads/ |
| | 12-19.log | test.exe |

Table 7 presents a selected set of features from the feature set generated for the BR pair shown in Table 6 by an instant feature engineering pipeline 112 or 212 of the above teachings. Note the combined features for the pair of BRs of Table 6 in the first four columns of Table 7.

TABLE 7

| | | | |
|---|---|---|---|
| priority_match | 0 | vrt1_1 | 0 |
| bug_url_match | 0 | vrt1_2 | 0 |
| target_id_match | 0 | vrt1_3 | 0 |
| no_suburls_match | 1 | vrt1_4 | 0 |
| desc1_0 | 1 | vrt1_316 | 0 |
| desc1_1 | −0.06029 | vrt1_317 | 0 |
| desc1_2 | 0.447456 | vrt1_318 | 0 |
| desc1_3 | 0.06194 | vrt1_319 | 0 |
| desc1_4 | −0.08925 | vrt1_320 | 0 |
| desc1_763 | −0.19691 | desc2_0 | 0 |
| desc1_764 | −0.02851 | desc2_1 | 0.079299 |
| desc1_765 | −0.23281 | desc2_2 | 0.445142 |
| desc1_766 | 0.290495 | desc2_3 | −0.00241 |
| desc1_767 | −0.37572 | desc2_4 | −0.00833 |
| cap1_0 | −0.06146 | desc2_763 | −0.03242 |
| cap1_1 | −0.10284 | desc2_764 | 0.014647 |
| cap1_2 | 0.600723 | desc2_765 | 0.044435 |
| cap1_3 | 0.293376 | desc2_766 | 0.209231 |
| cap1_4 | −0.05455 | desc2_767 | −0.2801 |
| cap1_763 | −0.04818 | cap2_0 | −0.05263 |
| cap1_764 | −0.39972 | cap2_1 | 0.216718 |
| cap1_765 | −0.37436 | cap2_2 | 0.492297 |
| cap1_766 | −0.00878 | cap2_3 | 0.045134 |
| cap1_767 | −0.14439 | cap2_4 | −0.00743 |
| vrt1_0 | 0.095613 | cap2_763 | 0.330461 |
| cap2_764 | −0.30597 | vrt2_3 | 0 |
| cap2_765 | 0.208238 | vrt2_4 | 0 |
| cap2_766 | 0.252018 | vrt2_316 | 0 |
| cap2_767 | −0.27506 | vrt2_317 | 0 |
| vrt2_0 | 0.15199 | vrt2_318 | 0 |
| vrt2_1 | 0 | vrt2_319 | 0 |
| vrt2_2 | 0 | vrt2_320 | 0 |

In a converse use-case of the present technology, a trained feed-forward neural network (FFNN) of the above teachings is used to determine whether a bug report or BR is highly distinct or unique as compared to other BRs. This is accomplished by training the FENN per above teachings on a corpus/set of BRs and identifying a threshold score below which a pair of BRs is considered distinct i.e. has BRs that are very different or distinct from each other. Then, for a given BR of interest, such as a new BR, BR pairs are generated with the existing BRs in the corpus. If all these BR pairs score below the threshold, that means that the BR is distinct or unique or novel as compared to the rest of the BRs in the corpus/set.

In view of the above teachings, a person skilled in the art will recognize that the methods of present invention can be embodied in many different ways in addition to those described without departing from the principles of the invention. Therefore, the scope of the invention should be judged in view of the appended claims and their legal equivalents.

What is claimed is:

1. A computer-implemented method for executing by at least one microprocessor, computer-readable instructions stored in a non-transitory storage medium coupled to said at least one microprocessor, said computer-implemented method comprising the steps of:
(a) deriving by a feature engineering pipeline, a first group of feature sets for respective pairs of bug reports in a first set of bug reports, said deriving based on a vulnerability rating taxonomy, priority levels of said bug reports, textual components of said bug reports, uniform resource locators of said bug reports and targets identified in said bug reports, wherein said first group of feature sets is represented by a first group of respective fixed-length feature vectors;
(b) tuning and training a feed forward neural network to obtain a trained feed forward neural network, said training based on said first group of fixed-length feature vectors, wherein said feed forward neural network generates a first set of probabilities, each corresponding to a pair of bug reports amongst said respective pairs of bug reports in said first set of bug reports;
(c) identifying a duplicate bug report probability threshold from said first set of probabilities;
(d) receiving a new bug report and deriving by said feature engineering pipeline, a second group of feature sets for respective pairs of bug reports derived from said new bug report and a second set of bug reports, wherein said second group of feature sets is represented by a second group of respective fixed-length feature vectors; and
(e) running said trained feed forward neural network on said second group of fixed-length feature vectors to generate a second set of probabilities for said respective pairs of bug reports derived from said new bug report and said second set of bug reports, and identifying those amongst said second set of probabilities that are equal to or greater than said duplicate bug report probability threshold.

2. The computer-implemented method of claim 1, wherein said first set of bug reports is partitioned into a training portion, a test portion and a validation portion for said training.

3. The computer-implemented method of claim 1, wherein said second set of bug reports contains bug reports of one of an active bug bounty program and all bug bounty programs of an organization.

4. The computer-implemented method of claim 1 employed for triaging bug reports in a bug bounty program.

5. The computer-implemented method of claim 1, wherein said feed forward neural network employs three hidden layers.

6. The computer-implemented method of claim 5, wherein said feed forward neural network employs an input layer with Rectified Linear Unit (ReLU) activation and Batch Normalization.

7. The computer-implemented method of claim 1, wherein said feed forward neural network employs an output layer having one neuron with sigmoid activation for binary classification.

8. The computer-implemented method of claim 1, wherein said feature engineering pipeline employs one-hot-encoding of tags of said vulnerability rating taxonomy to derive features in said first group and said second group of feature sets.

9. The computer-implemented method of claim 1, wherein said feature engineering pipeline employs a version of the BERT (Bidirectional Encoder Representations from Transformers) model specialized for that is cybersecurity, for embedding said textual components of said bug reports.

10. The computer-implemented method of claim 1, wherein said feature engineering pipeline processes said uniform resource locators based on the number of backslashes in said uniform resource locators.

11. The computer-implemented method of claim 1, wherein each target amongst said targets is represented by a target ID, and wherein said feature engineering pipeline represents said each target as a boolean feature of said pair of bug reports based on whether each bug report in said pair of bug reports references said target ID.

12. A computer system comprising computer-readable instructions stored in a non-transitory storage medium and at least one microprocessor coupled to said non-transitory storage medium when executing said computer-readable instructions, said computer system further comprising:
(a) a first set of bug reports;
(b) a feature engineering module for deriving a first group of feature sets for respective pairs of bug reports in 9 said first set of bug reports, said deriving done by employing a vulnerability rating taxonomy, priority levels of said bug reports, textual components of said bug reports, uniform resource locators of said bug reports and targets identified in said bug reports, wherein said first group of feature sets is represented by a first group of respective fixed-length feature vectors;
(c) a feed forward neural network trained on said first group of fixed-length feature vectors, wherein said feed forward neural network generates a first set of probabilities, each corresponding to a pair of bug reports amongst said respective pairs of bug reports in said first set of bug reports, and wherein a duplicate bug report probability threshold is identified from said first set of probabilities; and
(d) a submission receiving module for receiving a new bug report;
wherein said feature engineering module is used to derive a second group of feature sets for respective pairs of bug reports derived from said new bug report and a second set of bug reports, and wherein said second group of feature sets is represented by a second group of respective fixed-length feature vectors, and wherein said feed forward neural network is executed on said second group of fixed-length feature vectors to generate a second set of probabilities for said respective pairs of bug reports derived from said new bug report and said second set of bug reports, and wherein those probabilities are identified amongst said second set of probabilities that are equal to or greater than said duplicate bug report probability threshold.

13. The computer system of claim 12 employed for triaging bug reports in a bug bounty program.

14. The computer system of claim 12, wherein said feed forward neural network employs three hidden layers.

15. The computer system of claim 12, wherein a tuning of said feed forward neural network is performed based on Receiver Operating Characteristic-Area Under the Curve (ROC AUC) scores derived from a test portion of said first set of bug reports.

16. The computer system of claim 12, wherein said feed forward neural network employs an output layer having one neuron with sigmoid activation for binary classification.

17. The computer system of claim 12, wherein said feature engineering pipeline employs one-hot-encoding of tags of said vulnerability rating taxonomy to derive features in said first set and said second set of feature sets.

18. The computer system of claim 12, wherein said feature engineering pipeline employs version of the BERT (Bidirectional Encoder Representations from Transformers) model that is specialized for cybersecurity, for embedding said textual components of said bug reports.

19. The computer system of claim 12, wherein said feature engineering pipeline processes said uniform resource locators based on the number of backslashes in said uniform resource locators.

20. The computer system of claim 12, wherein each target amongst said targets is represented by a target ID, and wherein said feature engineering pipeline represents said each target as a boolean feature of said pair of bug reports based on whether each bug report in said pair of bug reports references said target ID.
